(19) United States
(12) Patent Application Publication
(10) Pub. No.: US 2021/0075863 A1
(43) Pub. Date: Mar. 11, 2021

(54) EDGE COMPUTING DEPLOYMENT AND MANAGEMENT

(71) Applicant: EVANGELOS ACHILLOPOULOS, ALIMOS (GR)

(72) Inventor: EVANGELOS ACHILLOPOULOS, ALIMOS (GR)

(21) Appl. No.: 17/013,341

(22) Filed: Sep. 4, 2020

Related U.S. Application Data
(60) Provisional application No. 62/896,574, filed on Sep. 6, 2019.

(51) Int. Cl. H04L 29/08; G07C 9/00

(52) U.S. Cl. CPC H04L 67/125; G07C 9/00182; H04L 67/1097

(57) ABSTRACT

The present disclosure relates to a modular and portable system architecture which enables Edge Cloud physical infrastructure building blocks to be portable and managed from a software platform with personnel at the field that will move the building blocks assisted from the platform in order for the system supply capacity to be able to follow the geographically distributed user process and storage demand. By this arrangement and operation, the overprovisioning CAPEX needed from operators to support the fluctuations of system capacity demand from location to location is minimized while at the same time minimizing the OPEX costs of service and maintenance of the system.

### RELATED APPLICATION

This application claims the benefit of U.S. Provisional Patent Application No. 62/896,574, filed on Sep. 6, 2019.

### BACKGROUND

### Field

The present disclosure relates to techniques for edge computing deployment and management.

### Background Information

Edge computing is a distributed computing paradigm which brings computation and data storage closer to the location where it is needed. The increase of IoT devices at the edge of the network is producing a massive amount of data to be computed to data centers, pushing network bandwidth requirements to the limit. Despite the improvements of network technology, data centers cannot guarantee acceptable transfer rates and response times, which could be a critical requirement for many applications. Furthermore, devices at the edge constantly consume data coming from the cloud, forcing companies to build content delivery networks to decentralize data and service provisioning, leveraging physical proximity to the end user. In a similar way, the aim of Edge Computing is to move the computation away from data centers towards the edge of the network, exploiting smart objects, mobile phones or network gateways to perform tasks and provide services on behalf of the cloud. By moving services at the edge, it is possible to provide content caching, service delivery, storage and IoT management, resulting in better response times and transfer rates. At the same time, distributing the logic in different network nodes introduces new issues and challenges.

Edge application services reduce the volumes of data that must be moved, the consequent traffic, and the distance that data must travel. That provides lower latency and reduces transmission costs. Computation offloading for real-time applications, such as facial recognition algorithms, showed considerable improvements in response times as demonstrated in early research. Further research showed that using resource rich machines near mobile users, called cloudlets (aka, “edge data centers”, “far edge data centers”, and/or “mobile edge data centers”), offering services typically found in the cloud, provided improvements in execution time when some of the tasks are offloaded to the edge node. On the other hand, offloading every task may result in a slowdown due to transfer times between device and nodes, so depending on the workload an optimal configuration can be defined.

Other notable applications include connected, autonomous cars. smart cities and home automation systems.

As with any resource, edge computing resources, and especially data storage capacity, can be added or removed from a network node or site to achieve optimum or desired resource optimization, budgetary constraints, or other design use constraints.

One conventional approach to dealing with seasonal increase in computational throughput and data storage capacity in the hospitality industry, for example, is for IT departments to set up local server and data storage hosted locations, often at significant cost and overcapacity. The overprovisioning problem is particularly acute in new installations where there is no existing customer demand profile.

For larger enterprises with multiple non-collocated sites, multiple separate hosted locations may be necessary, adding to the cost, not to mention the difficulty to find, hire and keep skilled personnel gainfully employed to service the hosted locations properly.

While it is quite common to see edge computing installation today deployed in shipping containers, small rooms to create small data centers in various commercial buildings, and a variety of unique office and industrial environments, previously only reserved for dedicated, climate controller server rooms, this is in larger part due to the advancement of computer technology and processing power as much as anything else. As far as the racks themselves, and the conventions used to connect server and storage components onto racks, these remain virtually unchanged.

The problem with traditional rack systems is that they are not designed to withstand the hurdles of transporting, i.e., they are not designed to be shippable. Furthermore, existing rack-mounted server systems are not sized or dimensioned to be taken apart or easily broken down to make packaging and shipping possible, especially by single-manned courier services.

Moreover, the very complexity of rack-based server systems being what it is, only skilled personnel are authorized to tamper with the wiring and/or software provisioning of these cloud like technology systems.

In recent years, Amazon Inc. has been promoting its portable data storage device as a type of “portable edge server”, which it markets under the brand Amazon Snowball Edge device. The Amazon Snowball Edge device is, however, anything but a true data center. A true data center should have the ability to be self-powered, should be scalable and configurable to connect to other data servers in a fault tolerant manner, but it does not operate without an independent power source, it does not have the ability to create a network of fault tolerant data servers, nor does it have the ability to easily get an independent network connectivity of any kind, thus it can't be completely remotely managed. Also, in order to be connected or networked properly to a hosted location, a properly trained technical expert is required to set up and deploy. Once this is done, in theory, the Amazon device is capable of operating as an edge computing non-portable data center node.

Another Amazon solution is Amazon Outpost. This is also a rack system, and since one would require a forklift to move it, it is anything but portable in the conventional sense.

It is particularly desirable to find improved ways that facilitate adding and/or removing the appropriate edge computing resources to a node or set of nodes to meet current and future demand, including seasonal demand, and/or to accommodate unexpected emergencies or catastrophic events, or other similar needs.

### SUMMARY

The present disclosure relates to a modular and portable system architecture which enables Edge Cloud physical infrastructure building blocks to be portable and managed from a software platform with personnel at the field that will move the building blocks assisted from the platform in order for the system supply capacity to be able to follow the geographically distributed user process and storage demand, thus minimizing the overprovisioning CAPEX needed from operators to support the fluctuations of system capacity demand from location to location, while at the same time can minimize the OPEX costs of service and maintenance of the system.

The present disclosure further relates to techniques for provisioning a set of portable edge computing servers of an edge cloud system comprising: identifying demand based profile information from a set of customers in a given region, and on the basis thereof identifying the optimum combination of edge computing servers to deploy, including optimum computation and data storage capacity for each edge computing server based on geographic location; identifying a change in the demand based profile information from the same set of customers in the same region to create a reprovision profile; and generating new optimum combination of edge computing servers to deploy in the edge system in response to the reprovision profile.

On the basis of the reprovision profile, the edge system manager will instruct field personnel to identify which edge computing servers need to be swapped out with equipment that meet the new requirements set by the provisioning platform. In one embodiment, field personnel will drive out to the site and pull the portable edge computing server from its resting location while maintaining continuous network communication with the edge cloud system using its backup UPS power mode. In another embodiment, the newly provisioned edge computing server is ready to be physically deployed and swapped in place of the removed unit.

In another embodiment, the deployed unit sits in an autonomous vehicle (AV). In this case, deployment involves instructing the AV to return to base or to a different location. In turn, the newly deployed edge computing server is sent out on a similar AV and positioned in its place.

In still another embodiment, the swapped unit is deployed in a different location.

In still another embodiment, creating a reprovision profile involves deploying fewer edge computing servers.

In another embodiment, creating a reprovision profile involves deploying a higher number of edge computing servers.

In a further embodiment, creating a reprovision profile involves adding or removing application services from one or more edge computing servers.

Mobile Network operators have traditionally faced challenges with cell load demand fluctuations. The typical solution is to add “mobile” cell towers built around specially fitted vehicles. The vehicles are positioned to divide further the served area in order to add capacity. The vehicles are equipped with motorized telescopic antenna masts that function as added antenna towers.

In a similar manner as added antenna towers, edge computing servers can be fitted to vehicles or similar moving geographically deployable in order to move and supply the extra process and data storage capacity the system needs. But there is a difference. Edge just needs a network connection, power and a secure location to be placed to operate. No antenna mast is needed, actually nothing extreme or special is needed. Edge Computing servers do not need to be bolted in a van as a Mobile Cell needs in order to operate.

This fact makes possible a totally portable and shippable solution feasible, whereas Devices, Logistics (transportation) and Host Locations can be managed separately, even from separated operators and in an orchestrated fashion to minimize all costs, CAPEX and OPEX.

A new operational concept can be realized for edge computing where the hardware resources can move from host location to host location as needed, providing the elasticity the system needs to overcome the demand mobility of edge computing load, thus minimizing CAPEX and OPEX while at the same time ensuring that maintenance and support expenditures by non-expert personnel are feasible, giving much more flexibility during deployment and operation.

### BRIEF DESCRIPTION OF THE DRAWINGS

FIG. 1 shows the system setup according to an embodiment of the present invention.

FIG. 2 shows a common configuration for building blocks portable devices in the system of the present invention.

FIG. 3 shows an exemplary illustration of a portable device used in the system of the present invention.

FIG. 4 shows the process oriented portable device exemplary configuration in the system of the present invention.

FIG. 5 shows the data storage oriented portable device exemplary configuration in the system of the present invention.

FIG. 6 shows the Network oriented portable device exemplary configuration in the system of the present invention.

FIG. 7 shows an exemplary host location with a secure cabinet in front view with shelf slots and individual locker doors in the system of the present invention.

### DETAILED DESCRIPTION

The word “exemplary” is used herein to mean “serving as an example, instance, or illustration.” Any embodiment described herein as “exemplary” is not necessarily to be construed as preferred or advantageous over other embodiments. It is to be understood that the terminology used herein is for purposes of describing particular embodiments only and is not intended to be limiting. The defined terms are in addition to the technical and scientific meanings of the defined terms as commonly understood and accepted in the technical field of the present teachings.

As used in the specification and appended claims, the terms “a”, “an” and “the” include both singular and plural referents, unless the context clearly dictates otherwise. Thus, for example, “a system” or “a device” includes one system or device as well as plural systems or devices.

The present disclosure relates to a modular and portable system architecture which enables Edge Cloud physical infrastructure building blocks to be portable and managed from a software platform with personnel at the field that will move the building blocks assisted from the platform in order for the system supply capacity to be able to follow the geographically distributed user process and storage demand, thus minimizing the overprovisioning CAPEX needed from operators to support the fluctuations of system capacity demand from location to location, while at the same time minimizing the OPEX costs of service and maintenance of the system.

The present disclosure further relates to techniques for provisioning a set of portable edge computing servers of an edge cloud system comprising: identifying demand based profile information from a set of customers in a given region, and on the basis thereof, identifying the optimum combination of edge computing servers to deploy, including optimum computation and data storage capacity for each edge computing server based on geographic location; identifying a change in the demand based profile information from the same set of customers in the same region to create a reprovision profile; and generating new optimum combination of edge computing servers to deploy in the edge system in response to the reprovision profile.

On the basis of the reprovision profile, the edge system manager will instruct field personnel to identify which edge computing servers need to be swapped out with equipment that meet the new requirements set by a provisioning platform. In one embodiment, field personnel will drive out to the site and pull the portable edge computing server from its resting location while maintaining continuous network communication with the edge cloud system using its backup UPS power mode. In another embodiment, the newly provisioned edge computing server is ready to be physically deployed and swapped in place of the removed unit.

In another embodiment, the deployed unit sits in an autonomous vehicle (AV). In this case, deployment involves instructing the AV to return to base or to a different location. In turn, the newly deployed edge computing server is sent out on a similar AV and positioned in its place.

In another embodiment, the swapped unit is deployed in a different location.

In a further embodiment, creating a reprovision profile involves deploying fewer edge computing servers.

In yet another embodiment, creating a reprovision profile involves deploying a higher number of edge computing servers.

In still another embodiment, creating a reprovision profile involves adding or removing application services from one or more edge computing servers.

Mobile Network operators have traditionally faced challenges with cell load demand fluctuations. The typical solution is to add “mobile” cell towers built around specially fitted vehicles. The vehicles are positioned to divide further the served area in order to add capacity. The vehicles are equipped with motorized telescopic antenna masts that function as added antenna towers.

In a similar manner as added antenna towers, edge computing servers can be fitted to vehicles or similar moving geographically deployable in order to move and supply the extra process and data storage capacity the system needs. But there is a difference. Edge just needs a network connection, power and a secure location to be placed to operate. No antenna mast is needed. Also, edge computing servers do not need to be bolted down in a vehicle in the same way as, for example, a mobile cell tower, in order to safely operate.

This fact makes possible a totally portable and shippable solution feasible, whereas Devices, Logistics (transportation) and Host Locations can be managed separately, even from separated operators and in an orchestrated fashion to minimize all costs, CAPEX and OPEX.

A new operational concept can be realized for edge computing where the hardware resources can move from host location to host location as needed providing the elasticity the system needs to overcome the demand mobility of edge computing load thus minimizing CAPEX and OPEX while at the same time ensuring that maintenance and support expenditures by non-expert personnel are feasible giving much more flexibility during deployment and operation.

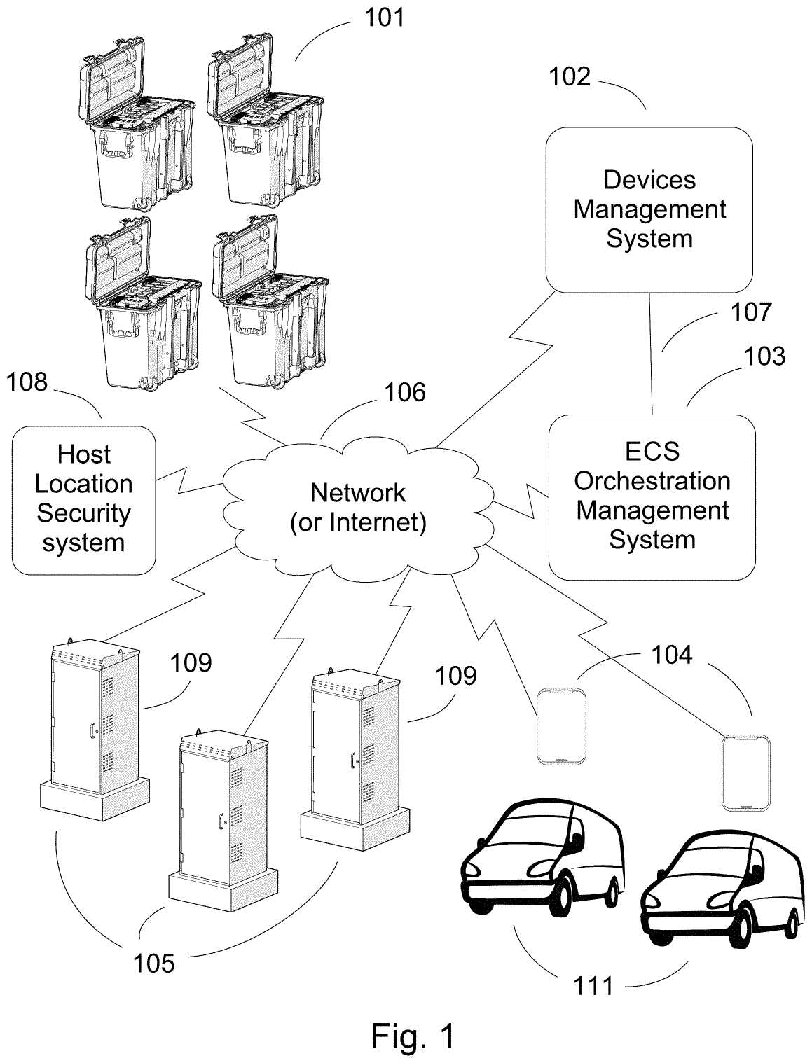

The present disclosure relates to a system architecture for the Edge Cloud physical infrastructure and support. Additionally, a business method where the disclosed modular system will allow the mobility of data process and storage resources in order for an operator to be able to move the resources easily from location to location in order to meet the Edge Computing Service (ECS) cloud demand migrating from location to location. Exemplary embodiments of the system of the present invention is described in conjunction with FIGS. 1-7 discussed below, wherein like numerals represent like elements throughout the figures.

FIG. 1 shows the system setup according to an embodiment of the present invention. Portable modular devices 101 comprise the IT building blocks of the system. A Devices Management System (DMS) 102 software platform is configured to manage the deployment of devices 101 geographically. An ECS Orchestration Management (ECSOM) system 103 is configured to handle the whole ECS infrastructure management and control, deploys services for clients, handles billing, tracks the health of the devices, and controls the user load on deployed servers. A plurality of vans 111 with non-expert Drivers with smartphones 104 is configured to be connected to the DMS 102 through internet using secure communication protocols. A basic host infrastructure 105 is configured to accept a plurality of portable modular devices 101. Network or internet connection 106 is provided between all the above either with wired means or wireless, using secure communication protocols.

In an alternative exemplary embodiment, the host locations are configured to be equipped with a Host Location Security Mechanism (HLSM) system 109 that will communicate through network or internet connection 106 with wired or wireless means using secure communication protocols with a Host Location Security (HLS) system or platform 108 with which a real estate operator will manage the host locations, usage and billing.

In an exemplary embodiment, such devices can be split into three main building blocks. There can be other configurations with more or less building blocks (even with one) to cover different needs.

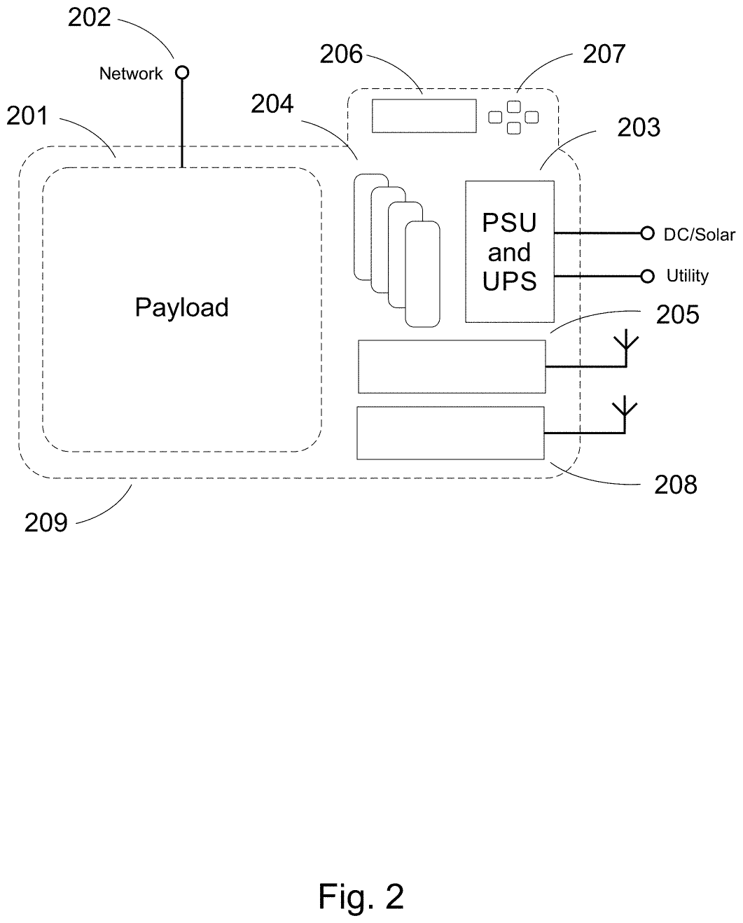

FIG. 2 illustrates the following components common to all building blocks that carry a payload 201 of the active components of ECS 103 that communicate with Networking means 202. These include the integration of an Uninterruptible Power Supply (UPS) and a Power Supply Unit (PSU) 203 fully operational with DC sources (i.e., external batteries or a solar panel) or AC utility power, with removable and rechargeable batteries 204 on every portable modular device capable to support the device with no external power for more than 1 hour runtime at minimum. A chassis remote management system 205 is configured with means to communicate using secure communication protocols to DMS management platform wirelessly (3G, 4G, LTE, Satellite, WiFi etc.) and have a user interface with a small OLED screen or display 206 and a minimal keyboard 207. A secondary server and peripherals (network switch etc.) remote management module 208 is configured with means to communicate using secure communication protocols to the ECSOM platform wirelessly (3G, 4G, LTE, Satellite, WiFi etc.). A ruggedized shockproof chassis 209 is integrated in an environmental protection case which makes it waterproof and submersible, thus capable to be shippable “as is”. The chassis remote management system 205 is disclosed in the inventor's U.S. patent application Ser. No. 15/987,225, which is incorporated herein by this reference it its entirety.

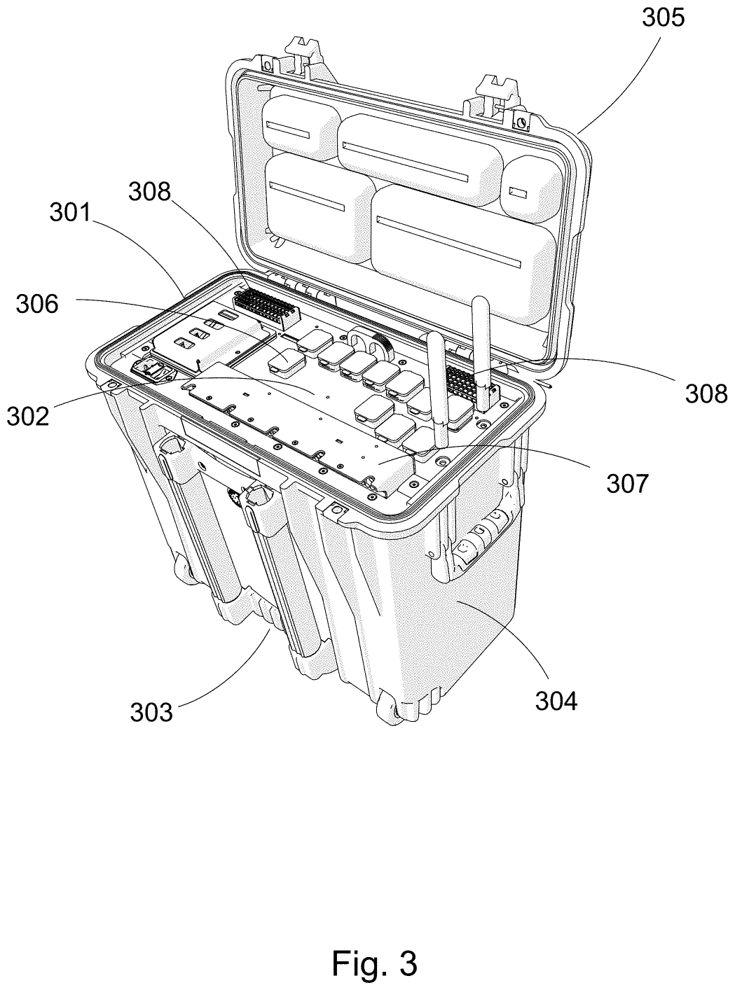

FIG. 3 shows an exemplary configuration of portable device 301 disclosed in the inventor's U.S. Pat. No. 9,977,481, which is incorporated herein by this reference in its entirety. Portable device 301 has top access 302 and is protected at the bottom 303 and on the sides of the case 304 from water and dust when the top lid 305 is open. By this construction, portable device 301 has the connection top panel 306, ventilation intake 307, and ventilation outtake 308 from one side (top side) where there is a lid 305 that opens to make accessible all the connections and allow the cooling 302 of the device during operation. Moreover, the connection top panel 306 has a water and dust protection (with the use of special connectors and covers) rating equivalent to IP52 when standing with open lid and a rating equivalent to IP54 when inclined with the air intake facing down with a device angle from standing position greater than 50 degrees down.

According to embodiments of the present disclosure, there can be provided many different portable device housings to carry a diversity of equipment with different shapes and physical protection technologies for shocks and water, all designs have to be lightweight enough in order to be handled by a single man during transport.

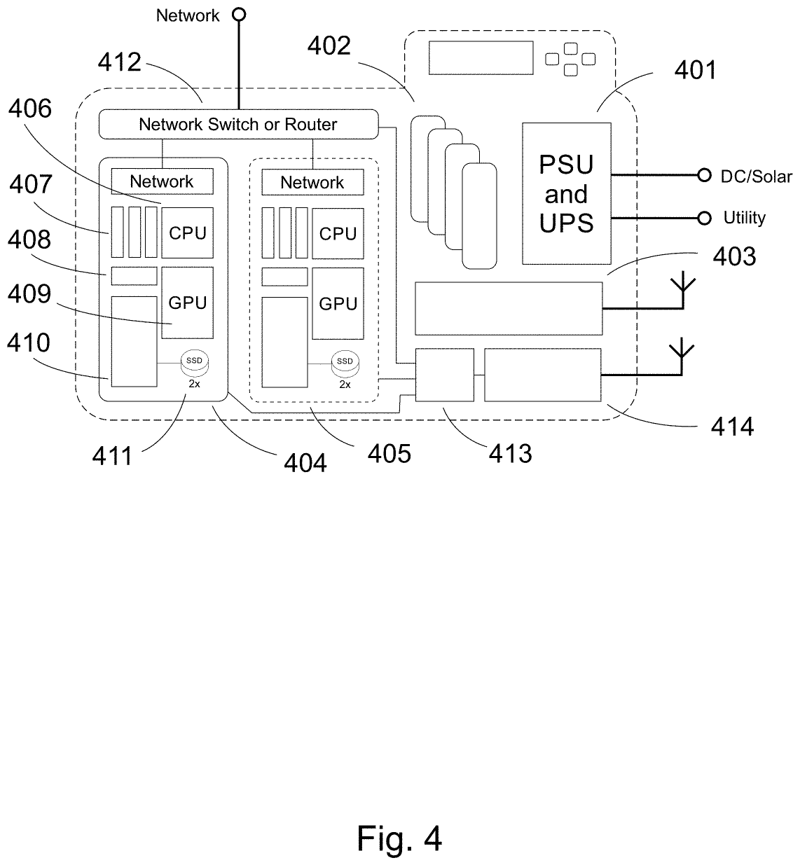

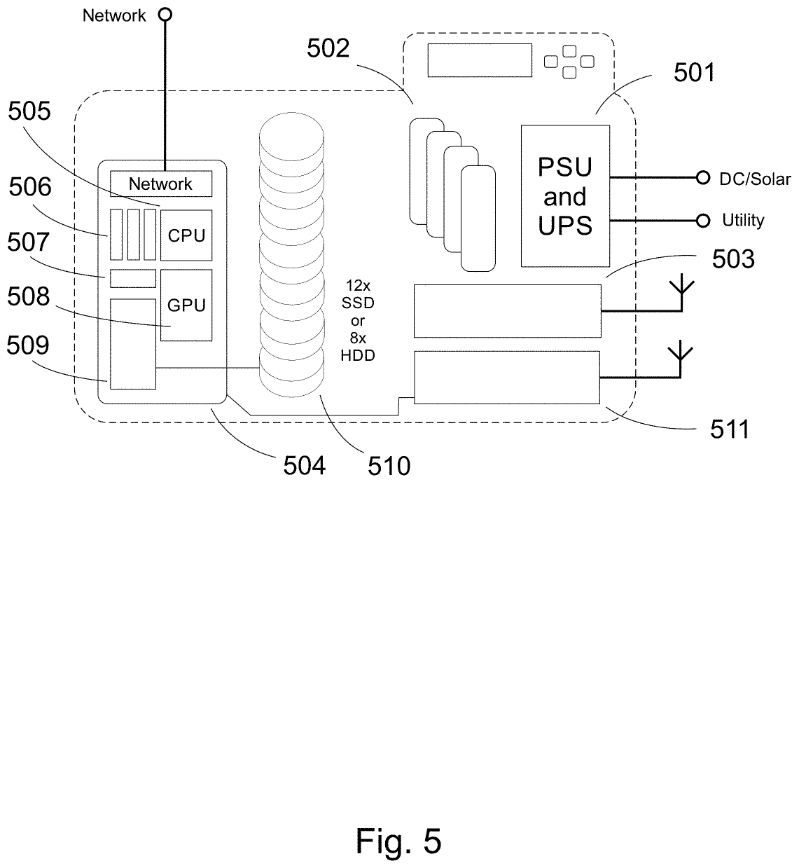

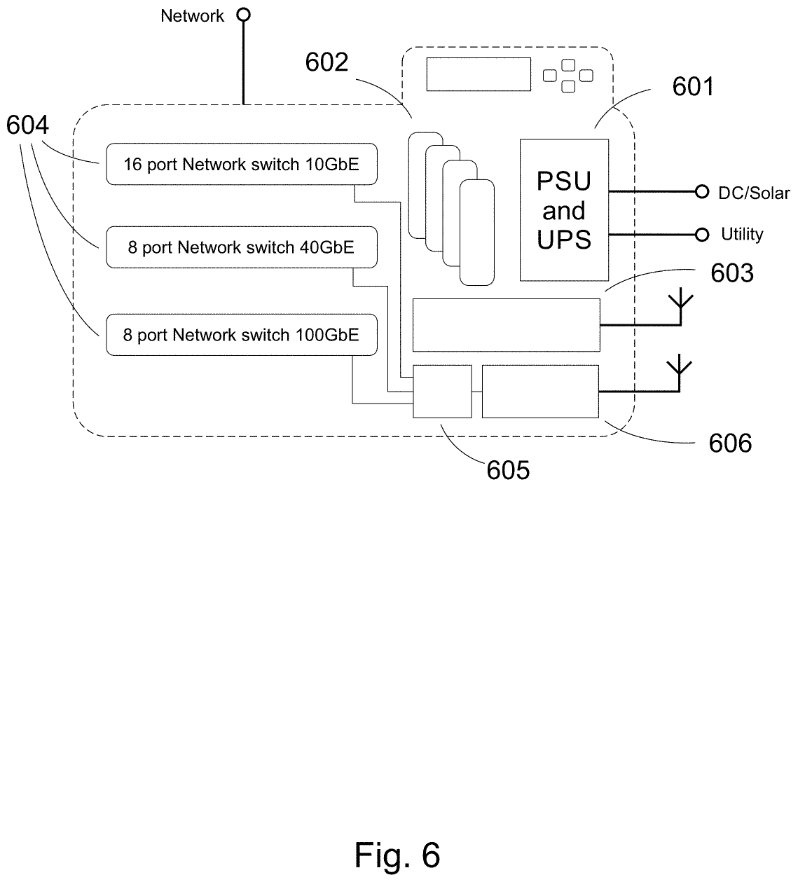

FIGS. 4-6 show an exemplary embodiment of three main building blocks of the system according to the present invention, including a process oriented portable device that will be more capable to process information and have a limited but very fast data storage (FIG. 4), a data storage oriented portable device that will have much more data storage but a bit slower than the process unit (FIG. 5), and a network oriented portable device with no process or storage capabilities but more suited for high speed networking and interfacing (FIG. 6).

Referring to FIG. 4, the process oriented portable device comprises, in an exemplary embodiment: a PSU and UPS 401; batteries 402; a chassis remote management and control system 403 as referred to above; one or two server node modules 404, 405 with a multicore Central Processing Unit (CPU) 406; a Random Access Memory (RAM) 407; a bootable SSD drive 408; expansion slots to add expansion cards such a Graphics Processing Unit (GPU) 409, and/or a high speed flash drive, and/or a Solid State Disk (SSD) controller 410, or other add-on cards depending on the application, a 4×2.5″ SSD drive bay for extra storage 411; a multiport high speed network switch or router module 412 to interconnect the server node modules internally (or externally depending on the configuration) with also the other modular portable devices; and a secondary low speed network switch 413 to interconnect the Server node modules with the high speed switch remote management subsystem with a secondary remote management system 414 that has wireless communication (e.g., a router with 3G, 4G, LTE, Satellite, WiFi etc., capabilities) that will give an alternative communication path only for provisioning the Server node modules and the high speed switch from the EC SOM using secure communication protocols.

Referring to FIG. 5, the data storage oriented portable device comprises, in an exemplary embodiment of the invention: a PSU/UPS 501; batteries 502; a chassis remote management and control system 503 as referred to above; one server node module 504 with multicore CPU 505; RAM 506; a bootable SSD drive 507; expansion slots to add expansion cards, such as a GPU 508, and/or a high speed flash drive, and/or a SSD or Hard Disk Drive (HDD) controller 509, or other add on cards depending on the application; an 8×3.5″ SSD or HDD drive bay 510 for data storage to have large data capacity; and a secondary remote management system 511 that has wireless communication (e.g., a router with 3G, 4G, LTE, Satellite, WiFi, etc. capabilities) that will give an alternative communication path only for the remote management communications of the Server node module for provisioning the system from the ECSOM using secure communication protocols.

Referring to FIG. 6, the network oriented portable device comprises, in an exemplary embodiment: a PSU/UPS 601; batteries 602; a chassis remote management and control system 603 as referred to above 603; multiple networking switching/routing modules 604 (i.e., as many as are needed and can fit in the portable device) offering, in an exemplary embodiment, multiport switch or routing for 1 GbE, 10 GbE, 25 GbE, 40 GbE, 56 GbE, 100 GbE using copper or fiber; and a low speed (1 GbE) network switch 605 to interconnect the networking switching/routing modules with the secondary remote management system 606 that has wireless communication (e.g., a router with 3G, 4G, LTE, Satellite, WiFi etc., capabilities) that will give an alternative communication path only for the remote management communications of the switch/routing modules for the provisioning of said modules from the ECSOM using secure communication protocols.

As mentioned above, there can also be other building blocks with different configurations depending on the needs of the applications that are running on the Edge Compute system. Moreover, the building blocks are configured to operate stand-alone without any special data room configuration or host facilities.

In another exemplary embodiment, the portable process-oriented device and the portable storage-oriented devices are also configured so as to have all of the network switch and routing capabilities to interconnect up to a certain number of devices to form clusters in a way that can form the equivalent of a small data center without other external equipment needed apart from power and wide area networking connection. With the use of the extra network oriented portable devices in single or redundant setups, the system could grow further to form large clusters of servers and storage in a way that can form the equivalent of a medium or large size data center.

In another exemplary embodiment, a single portable process-oriented device can form an extremely small “data center in a box” that can offer the full spectrum of software services as a regular data center does. In a further exemplary embodiment two portable process-oriented devices interconnected can make a redundant extremely small data center. By adding another one or two storage oriented portable devices, a bigger data center with more storage can be provided. By adding more building blocks while all the others are operating, the system can be grown even further.

The portable devices are the building blocks of a data center system that can grow and shrink in process and storage capabilities just by adding or removing portable devices, thus forming an elastic data center that can also be moved and operate in all host location conditions without the need of anything special apart from power and wide area networking connections.

Moreover, said data center can be split to smaller data centers using fewer building blocks in order to mix process and storage resources to match the Edge Computing user demand in different areas. Any combination of building blocks can be used dynamically as the user demand changes over time simply by moving physically the portable devices as needed from a single portable device to a large deployment for 10s or 100s of portable devices.

Referring again to FIG. 1, in another exemplary embodiment an Edge Computing Service (ECS) provider will own a fleet of portable devices 101 that can be used to offer Edge Computing Services in a service area. The portable devices will be used and operate in specific host locations 105 owned by the ECS provider or leased from a third party.

According to a feature of the present invention, being able to operate the portable devices in host locations 105 with minimal infrastructure requirements allows the real estate of the host locations 105 to be managed by separate operators with ease. In another exemplary embodiment, the real estate operator may use the more advanced management system with the HLS platform 108 and the HLSM system 109 integrated in host locations 105.

ECS providers will also operate the Devices Management System (DMS) software platform 102 that will manage the deployment of the devices geographically. The provider will be able to see where the ECS needs more resources and what kind, by tracking the ECSOM System 103 usage in real-time. Historical data will be able to predict using AI algorithms or other algorithms developed by the ECS provider or the network provider, will propose the needed transfers of resources to different host locations to cover the user Demand or propose adding new resources from the local inventory pool.

The two systems DMS 102 and ECSOM 103 are connected directly, as denoted at 107, if it's being operated by the same operator, or through the network 106 using secure communication protocols if it is being operated by different operators in order to exchange information. For this operation to be realized and in order to pass all the information collected from the portable devices, an Application Programming Interface that will connect the two systems is provided.

The ECS provider will have non-expert personnel (Drivers) equipped with tablets or smartphones 104 running a client application for the DMS platform 102 to drive with vans 111 in order to go to host locations 105 to remove or add portable devices. The DMS 102 will handle the assignments to the Drivers to go and remove the portable devices that need to be moved from a host location 105 to another host location, or to add a portable device to a host location that comes from another location or from a local ECS service center inventory pool.

The DMS platform will handle the remote turning off of the Portable Devices that will need to be removed and as well as the power up of the devices added to a new location. The DMS platform will also track the location of the Drivers using the application on the tablet or smartphone of the Driver, as well as the location of the Portable Device using the Chassis Remote Management integrated on each device.

The Portable Devices are further configured with optical and sound means to attract attention of the Driver on which device is selected for insertion or extraction. Additionally, the portable devices may display a QR code in their display 206 (FIG. 2) that was transmitted to the devices through the DMS platform 102 (FIG. 1), and the Drivers will use their tablet or smartphone application 104 to scan with the integrated camera of their tablet or smartphone 104 the codes from the screen. By this arrangement, the DMS platform 102 is configured to verify that the Driver is pulling the correct device.

The Driver will verify the operation on the application, and it will move to the next. Additionally, the application may assist the Driver to find the host location 105 using a navigation map that will also act a security measure for the DMS platform to verify that the Driver didn't divert or tried to breach security of the Portable devices he carries.

The DMS platform will only take control from the ECSOM system when a Portable Device needs to be moved or deployed and will hand over back the control to the ECSOM system when the process of movement or deployment has finished to add it to the ECS system.

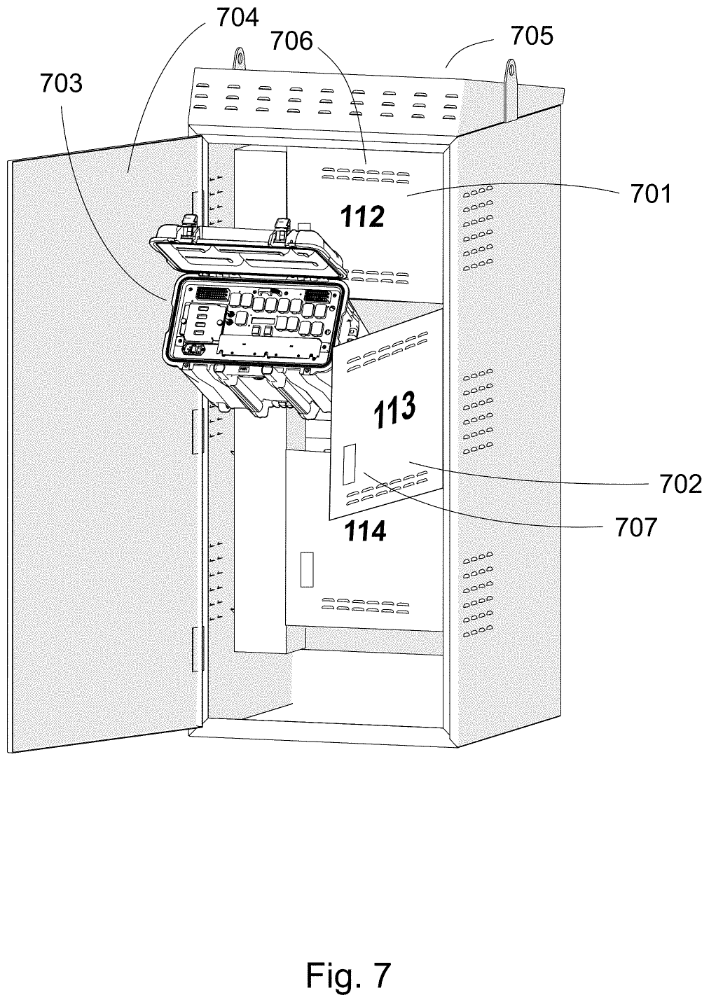

Referring to FIG. 7, host locations 105 of the ECS can be configured to accept the devices in special lockers 701 with doors or another kind of securing mechanism 702 that remotely open when the portable devices are turned off and ready to be removed, as denoted at 703. As described above with reference to FIG. 1, host locations 105 might have a remotely managed HLSM system connected with a central HLS platform 108 which in turn will be connected to the DMS platform software-wise through an Application Programming Interface and hardware-wise through Network (or Internet) or Wireless means (e.g., 3G, 4G, LTE, Satellite, WiFi etc.,) using secure communication protocols.

In another exemplary embodiments, host locations 105 might have multiple levels of security with doors 704 (FIG. 7) with a keyboard and a display that will open with limited and one-time passwords that will changed by the DMS platform through the HLS system every time a Driver needs to enter the host location to add or remove a portable device.

In another exemplary embodiment, lockers 701 are configured to be located inside cabinets 705 located in buildings, at the side of the road cabinets with multiply lockers, and/or inside small cargo container data centers. In another exemplary embodiments, lockers 701 are provided with a ventilation structure 706, power, batteries and networking connections.

In an alternative embodiment, lockers 701 can also be equipped with a keyboard and a display 707 that will open with limited and one-time passwords that will changed by the DMS platform 102 through the HLS system 108, as shown in FIG. 1, every time a Driver needs to enter the host location to add or remove a portable device.

In a further alternative embodiment, lockers 701 can be marked with QR codes or have the HLS and HLSM system to send one time QR codes that will be displayed on the locker display 707, and the Drivers will use their tablet or smartphone application 104 to scan with the integrated camera of their tablet or smartphone 104 the codes from the screen. By this arrangement, the DMS platform 102 will be able to verify with the HLS platform that the Driver is opening the correct locker.

Edge Data Centers are typically designed to support process loads and not act as Data Storage warehouses due to network traffic issues, thus raw data are thrown away after process. But with the advent of AI and machine learning, collected data are precious since they can be used to train AI algorithms as in the cases of autonomous driving vehicles and other applications. Additionally, users generate vast amounts of low priority data like archived videos etc., that want to transfer to the central cloud for storage and retrieval.

For this reason, the current method of transferring the Data Storage from the Edge Data Centers to the cloud infrastructure is to que the Data Load in a transfer process through the network when there is no traffic. This process has limitations in the maximum amount of data that is able to be transferred, due to network traffic conditions, before users generate new data that don't fit in the existing capacity.

According to the present invention, Storage Oriented Portable Devices fully loaded with data can be swapped with empty ones, and the fully loaded ones can be shipped back to the cloud infrastructure to be uploaded, and when empty can be returned back and be swapped again. By this arrangement and method, 200-400 TB can be moved with a single Portable Device within few days with minimal costs, when otherwise, many weeks would be needed for the transfer, relieving backbone network connections from the burden with considerable costs savings for the operators and the consumers.

The previous description of embodiments of the invention is provided to enable any person skilled in the art to make or use the invention. Various modifications to the disclosure will be readily apparent to those skilled in the art, and the generic principles defined herein may be applied to other variations without departing from the scope of the disclosure. Thus, the disclosure is not intended to be limited to the examples and designs described herein but are to be accorded the widest scope consistent with the principles and novel features disclosed herein.

What is claimed is:

1. A modular and portable system architecture for deploying and managing edge computing units capable of being managed from a remote software platform, with personnel at the field swapping and adding units as needed to satisfy capacity in terms of user process and storage demand.

2. A method of provisioning an edge cloud system comprising:
identifying demand based profile information from a set of customers in a given region, and on the basis thereof identifying the optimum combination of edge computing servers to deploy, including optimum computation and data storage capacity for each edge computing server based on geographic location;
identifying a change in the demand based profile information from the same set of customers in the same region to create a reprovision profile; and
generating new optimum combination of edge computing servers to deploy in the edge system in response to the reprovision profile.

3. A secure metal cabinet configured for use as a fixed station on a road including an internal compartment with a divider defining separate slots with a dedicated lock capable door designed to house an edge computing server of an edge cloud system.
